(19) United States
(12) Patent Application Publication
(10) Pub. No.: US 2018/0122011 A1
(43) Pub. Date: May 3, 2018

(54) SECURITIES TRADING MANAGEMENT SYSTEM

(71) Applicant: Nomura Research Institute, Ltd., Tokyo (JP)

(72) Inventors: Mitsuhiro TSUNODA, Tokyo (JP); Hideaki OHTSUBO, Tokyo (JP); Shunosuke KAJIMOTO, Tokyo (JP); Yoshichika HASHIMOTO, Tokyo (JP); Takahiro TANAKA, Tokyo (JP); Yuichiro SHIMOKAJI, Tokyo (JP)

(73) Assignee: Nomura Research Institute, Ltd., Tokyo (JP)

(21) Appl. No.: 15/852,771

(22) Filed: Dec. 22, 2017

Related U.S. Application Data
(63) Continuation of application No. PCT/JP2015/068073, filed on Jun. 23, 2015.

(51) Int. Cl. G06Q 40/04

(52) U.S. Cl. CPC G06Q 40/04

(57) ABSTRACT

A securities trading management system capable of linking dark pools provided by a plurality of sell sides or achieving a dark pool in which the plurality of sell sides participate and capable of also matching a potential order on a buy side is provided. According to a typical embodiment, the securities trading management system includes: one or more information processing systems including an order management system managing an order from a counterparty on the buy side or the sell side being a participant participating in securities trading; and a potential order pool system recording, in a database, information of an IOI of each of the participants obtained from each of the information processing systems and matching buying and selling between orders included in the respective IOI.

### TECHNICAL FIELD

The present invention relates to a technique for securities trading, and more particularly, relates to a technique effectively applied to a securities trading management system that supports a trading using a dark pool.

### BACKGROUND ART

A securities company (sell side) accepts a large quantity of orders for valuable securities trading from an asset management company (buy side) such as an institutional investor, and actually deals the trading through a market and others. In recent years, in order to, for example, avoid an influence on trade prices from performing a large-quantity buying and selling on the market, a service of a so-called dark pool that performs the trading by matching the investor's buying and selling orders in an information processing system on the sell side is provided. In this case, anonymity of order information such as information of a trading participant, a price, and an order quantity is secured, and improvements of an order execution rate and an order execution unit price and others can be expected, and therefore, use of the dark pool has been expanded among institutional investors who desire to keep an operation plan confidential, the operation plan being relative to buying and selling of an individual issue in a fund and others.

As a technique relative to the dark pool, for example, Japanese Patent Application Laid-Open Publication No. 2010-224710 (Patent Document 1) describes a mechanism that is capable of reducing a time loss involved in making a decision whether to forward an order to either an in-house dark pool or a stock exchange by taking a method of simultaneously transmitting new order information to both of an in-house trading system and an external trading market system.

Further, Japanese Patent Application Laid-Open Publication No. 2013-130936 (Patent Document 2) describes a mechanism that improves an order execution rate of an algorithm order having complicated order conditions under a dark pool environment by periodically performing matching processing between buying and selling order data at a predetermined interval based on a matching logic corresponding to an algorithmic trading group having a plurality of algorithmic trading types.

### RELATED ART DOCUMENTS

### Patent Documents

Patent Document 1: Japanese Patent Application Laid-Open Publication No. 2010-224710

Patent Document 2: Japanese Patent Application Laid-Open Publication No. 2013-130936

### SUMMARY OF THE INVENTION

### Problems to be Solved by the Invention

In a conventional technique, in the dark pool provided by each of the sell sides, each of the buy sides is capable of performing the trading while securing the anonymity of the order information. However, it is difficult to achieve a more sophisticated and extended mechanism that enhances liquidity such as linkage with a dark pool provided by another sell side and achievement of a dark pool to which a plurality of sell sides participate.

Further, in a conventional technique, the matching is performed based on an order that has actually been placed to establish the trading. However, for example, a future potential order planed in an operation plan by the buy side cannot be a subject of the matching, and therefore, the conventional technique consequently causes a case of the trading under a condition that is not always the best for a trading timing and an execution destination.

Thus, an object of the present invention is to provide a securities trading management system capable of achieving a linkage of a dark pool provided by a plurality of sell sides or a dark pool to which a plurality of sell sides participate and capable of matching even a potential order on the buy side.

The above and other object and novel characteristics of the present invention will be apparent from the description of the present specification and the accompanying drawings.

### Means for Solving the Problems

The summary of the typical aspects of the inventions disclosed in the present application will be briefly described as follows.

A securities trading management system according to a typical embodiment of the present invention is a securities trading management system that accepts an order from a counterparty and manages a securities trading performed by a sell side, and it includes: one or more information processing systems inducing an order management system in which the buy side or the sell side that becomes a participant participating in the securities trading manages an order from a counterparty; and a potential order pool system that records information on an indication of interest (IOI) of each of the participants to a database, the information being obtained from the information processing system, and that matches buying and selling between the orders included in each IOI.

### Effects of the Invention

The effects obtained by the typical aspects of the present invention disclosed in the present application will be briefly described below.

That is, according to the typical embodiment of the present invention, a linkage with a dark pool provided by a plurality of sell sides or a dark pool to which a plurality of sell sides participates can be achieved, and besides, a potential order on the buy side can be matched.

### BRIEF DESCRIPTIONS OF THE DRAWINGS

FIG. 1 is a diagram illustrating an outline of a configuration example of a securities trading management system according to a first embodiment of the present invention;

FIG. 2 is a diagram illustrating an outline of an example of a POP service according to the first embodiment of the present invention;

FIG. 3 is a diagram illustrating an outline of an example of matching between a buy side and a sell side in a POP according to the first embodiment of the present invention;

FIG. 4 is a sequence diagram illustrating an outline of an example of matching processing between the buy side and the sell side in the POP according to the first embodiment of the present invention;

FIG. 5 is a diagram illustrating an outline of an example of matching between the buy sides in the POP according to the first embodiment of the present invention;

FIG. 6 is a sequence diagram illustrating an outline of example of matching processing between the buy sides in the POP according to the first embodiment of the present invention;

FIG. 7 is a diagram illustrating an outline of another example of matching between the buy sides in the POP according to the first embodiment of the present invention;

FIG. 8 is a sequence diagram illustrating an outline of another example of matching processing between the buy sides in the POP according to the first embodiment of the present invention;

FIG. 9 is a diagram illustrating an outline of another example of matching between the buy side and the sell side in the POP according to the first embodiment of the present invention;

FIG. 10 is a sequence diagram illustrating an outline of an example of matching processing between the buy side and the sell side in the POP according to the first embodiment of the present invention;

FIG. 11 is a sequence diagram illustrating an outline of an example of matching processing between participants in the POP according to a second embodiment of the present invention; and

FIG. 12 is a sequence diagram illustrating an outline of another example of matching process between the participants in the POP according to the second embodiment of the present invention.

### BEST MODE FOR CARRYING OUT THE INVENTION

Hereinafter, embodiments of the present invention will be described in detail with reference to the accompanying drawings. Note that the same components are denoted by the same reference symbols in principle throughout all the drawings for describing the embodiments, and the repetitive description thereof will be omitted.

### First Embodiment

<System Configuration>

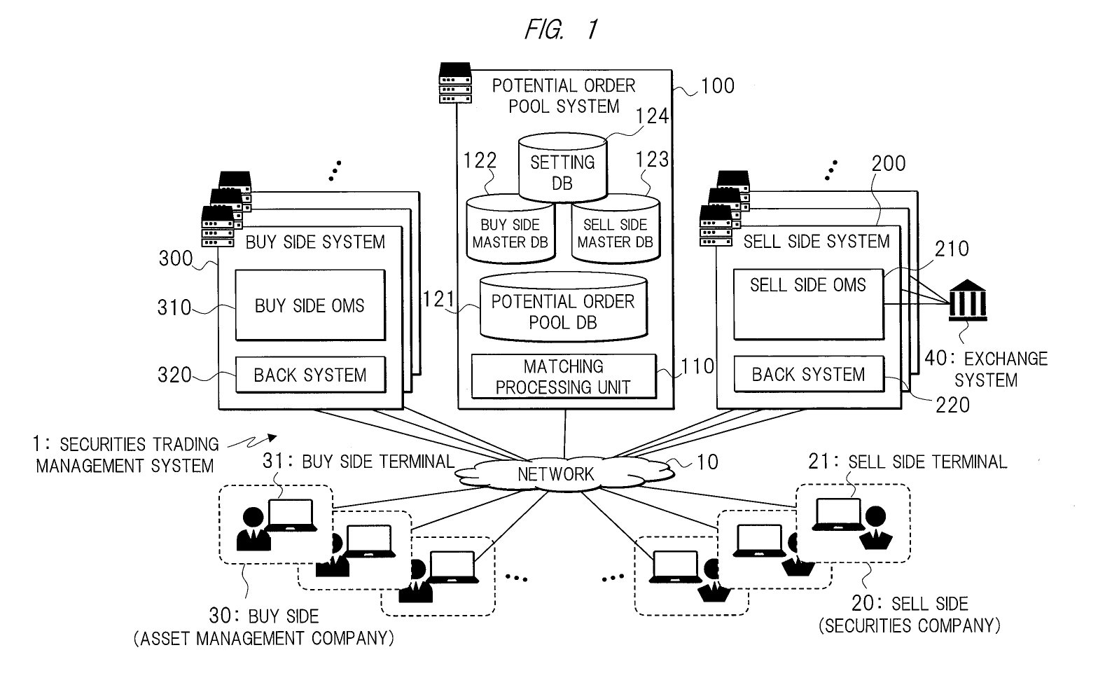

FIG. 1 is a diagram illustrating an outline of a configuration example of a securities trading management system according to a first embodiment of the present invention. A securities trading management system 1 has a configuration in which information processing systems such as a plurality of buy side systems 300, a plurality of sell side systems 200, and a potential order pool system 100 are connected to a network 10 such as the Internet. Each of the buy side systems 300 is the information processing system including an order management system of each of the buy sides 30 (an asset management company or others) or others, and each of the sell side systems 200 is the information processing system including an order management system of each of the sell sides 20 (a securities company or others) or others.

The potential order pool system 100 is the information processing system operated and managed by a business operator that is independent from and at a neutral position between each of the buy sides 30 and each of the sell sides 20, and it has a function of providing a “potential order pool (hereinafter, abbreviated as a “POP”)” service as an application service provider (ASP) service and others, the service establishing the trading by obtaining and accumulating information on indication of interest (IOI: “statement of trading intention”) including a “potential order” from each of the buy sides 30 and each of the sell sides 20 and by matching the buying and the selling.

A person in charge or others on each of the sell sides 20 accesses the sell side system. 200 of his or her own company by using a not-illustrated Web browser or others in a sell side terminal 21 which is an information processing terminal used by himself or herself, and performs operations on the sell side 20. The person in charge or others may also transmit or receive data by directly accessing the POP system 100. Similarly, a person in charge or others on each of the buy sides 30 accesses the buy side system 300 of his or her own company by using a not-illustrated Web browser or others in a buy side terminal 31 which is an information processing terminal used by himself or herself, and performs operations on the buy side 30. The person in charge or others may also transmit or receive data by directly accessing the POP system 100.

Each of the systems of the POP system. 100, the sell side system 200, and the buy side system 300 is implemented by, for example, one or more server devices, a virtual server constructed on a cloud computing service, or others. It is desirable to operate and monitor each of the systems on, for example, a common system platform by the same IT business operator from a viewpoint of provision of the POP service by centrally accumulating the information on the IOI including the “potential order” from the buy side 30 and the sell side 20. However, the operation and monitoring are not always limited to this manner.

The sell side system 200 includes, for example, a sell side OMS 210 that is an order management system (OMS: order management system) on the sell side 20, and a back system 220 that is a back office system. The sell side OMS 210 has a function of executing the buying and selling orders online to an exchange system 40 such as the Tokyo Stock Exchange through the network 10 or others. The buy side system 300 includes, for example, a buy side OMS 310 that is an order management system on the buy side 30, and a back system 320 that is a back office system.

The POP system 100 includes each data store such as a potential order pool (POP) database (DB) 121, a buy side master DB 122, a sell side master DB 123, and a setting DB 124, that are implemented by, for example, a database, a file table, or others. It may also include each unit such as a matching processing unit 110 implemented as software having a function of providing the POP service to each of the buy sides 30 and each of the sell sides 20.

The POPDB 121 is a table that stores information on the IOI including the “potential order” obtained from the sell side system 200 (or the sell side terminal 21) and the buy side system 300 (or the buy side terminal 31). It may store not only the information but also sharable data of various information used in order processing, such as data that has been accepted for disclosure between the buy side 30 and the sell side 20.

The buy side master DB 122 and the sell side master DB 123 are tables that hold master information on the buy side 30 and the sell side 20 that can receive the POP service by accessing the POP system 100, respectively. The table may also include account information on a user. The setting DB 124 is a table that holds various types of the setting information on operation and processing of the POP system 100 or others. It may also hold setting information unique to each of the sell sides 20 and each of the buy sides 30.

As the POP service, the matching processing unit 110 has a function of establishing the trading by obtaining and accumulating the information on the IOI including the “potential order” from each of the buy sides 30 and the sell sides 20 and matching the buying and selling by using a method described below. It may also have a function of relaying and mediating a notification relative to the trading establishment, subsequent order placement/acceptance between the buy side 30 and the sell side 20, and a processing for order execution.

<Potential Order Pool (POP) Service>

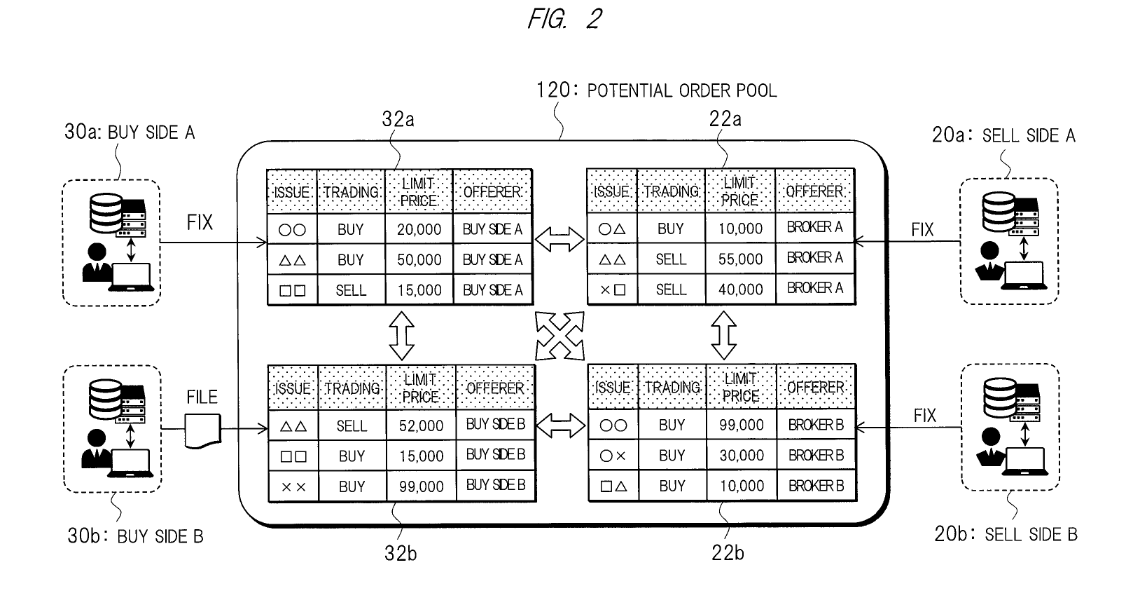

FIG. 2 is a diagram illustrating an outline of an example of the POP service according to the present embodiment. A potential order pool (POP) 120 is obtained by schematically illustrating a conceptual dark pool achieved by the POPDB 121, the matching processing unit 110, and others in the POP system 100.

In a trade between an investor and a securities company, the IOI is stated as useful reference information for establishing the trade to find a trading partner in some cases. In this case, the IOI includes contents of an order scheduled to be conducted, information on desirable or supportable conditions, or others. Therefore, by using this, a trade intended to be executed on that day can be efficiently matched and be established.

On the other hand, for example, an institutional investor (buy side 30) has a trade (hereinafter, referred to as a “potential order”) that is certainly scheduled to be conducted in the near future although not necessarily scheduled to be conducted on that day in some cases. The cases include, for example, a case in which a buying/selling timing is decided in accordance with an operation plan over a certain period of time, a case in which the buying/selling of a large quantity is distributed into a plurality of times in order to avoid an influence on the market, and others. In any case, information on what kind of the buying/selling is scheduled in the near future should be fundamentally concealed on the buy side 30, and it is general not to disclose the information.

However, such potential order is not a type of an order that is definitely conducted on a scheduled day in the future. For example, flexible handling such as the conduction of the buying/selling on that day regardless of the schedule is taken if a certain sell side 20 (broker) states the IOI with a particularly advantageous condition for a target issue on that day and it is decided that the buying/selling at this timing is effective. Conventionally, such decision has been made manually by, for example, a trader of the buy side 30 or others.

Therefore, while information confidentiality in the dark pool is utilized, the present embodiment forms the POP 120 by obtaining information on such a potential order as the IOI from the buy side 30 so as to be a matching target in the trading on that day.

As described above, for example, when the buy side system 300 and the POP system 100 are operated and managed by the same neutrally-positioned business operator, it can be said that a coverage for reference of the information on the potential order that has originally been managed by the buy side system 300 is only expanded by the same business operator, and therefore, there are less psychological and physical barriers for the information disclosure. Further, by using such a configuration in which each of the sell sides 20 states the IOI to the POP 120 that is operated and managed by the neutrally-positioned business operator, the dark pools of the plurality of the sell sides 20 can be linked with one another. Besides, transparency, fairness, and impartiality of the dark pool service can be ensured.

The example of FIG. 2 shows a state in which a buy side A (30a), a buy side B (30b), a sell side A (20a), and a sell side B (20b) participate in the POP 120 so that the IOI information including the potential order (illustrated in tables of IOI32a and 32b and IOI22a and 22b in the drawing) is registered. The POP system 100 obtains the IOI information from the buy side 30 and the sell side 20 through, for example, communication based on a Financial Information eXchange (FIX) protocol or transmission and reception of a file, and accumulates the IOI information in the POPDB 121, and matching of the buying and selling between the IOIs is performed by the matching processing unit 110. An algorithm of the matching or others is not particularly limited, and any publicly-known method can be appropriately used.

Note that an order-execution unit price at the time of matching can be set to, for example, a previous close price or a medium price of that day on a stock exchange. Further, the matching is not limited to be performed between the buy side 30 and the sell side 20, but also is performed between the buy sides 30 or between the sell sides 20 as described later. The information on the counterparty's trade contents that is reported to an object buy side 30 or an object sell side 20 when the matching is established is basically anonymized. However, for example, if the counterparty is previously registered in the setting DB 124 or others as a client, the information on the counterparty may be disclosed thereto.

<(1) Matching Between Buy Side and Sell Side>

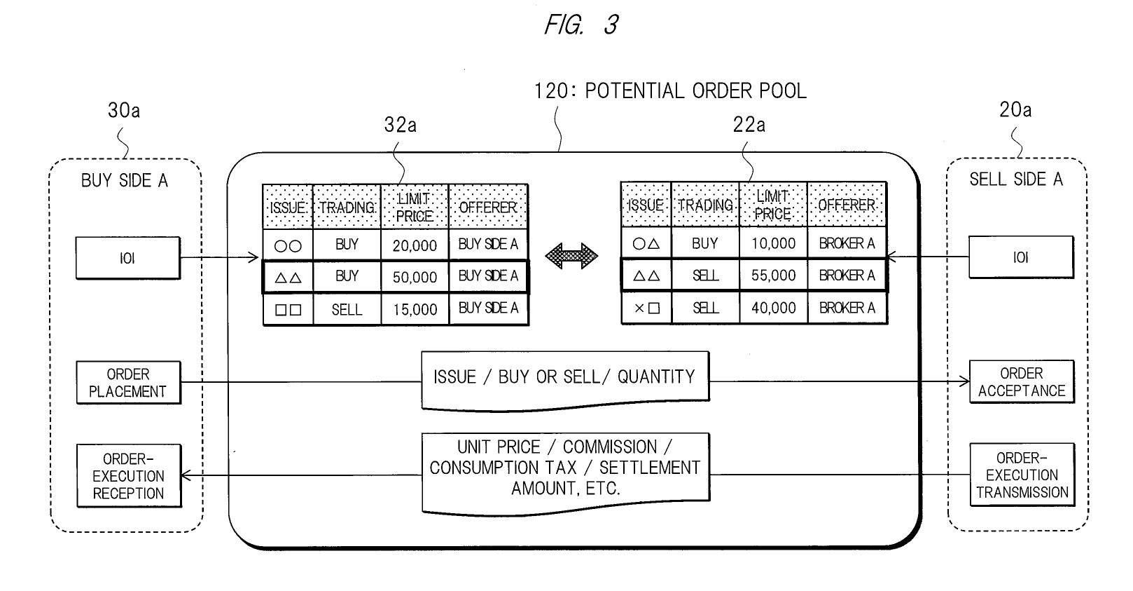

FIG. 3 is a diagram illustrating an outline of an example of matching between the buy side 30 and the sell side 20 in the POP 120 according to the present embodiment. The example of FIG. 3 shows that the buying and the selling are matched for an issue “ΔΔ” between the IOI 32a stated by the buy side A (30a) and the IOI 22a stated by the sell side A (20a).

In this case, for example, information on the order placement is transmitted from the buy side system 300 of the buy side A (30a) to the sell side system 200 of the sell side A (20a) by a message of the FIX protocol. On the sell side A (20a), the order to the exchange system 40 is executed based on the order placement information. The data on the order execution is sent to the buy side A (30a) by, for example, the transmission and reception of the file or others through the POP system 100.

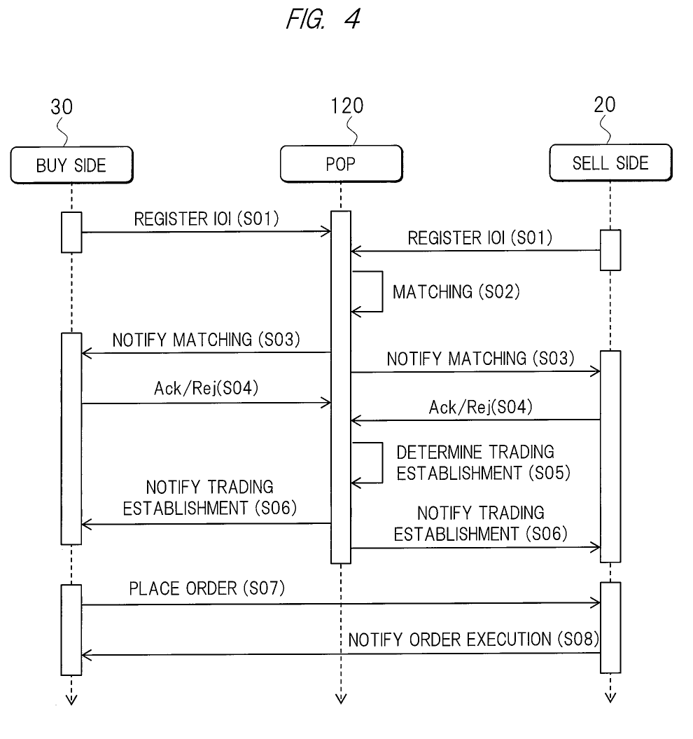

FIG. 4 is a sequence diagram illustrating an outline of an example of matching processing between the buy side 30 and the sell side 20 in the POP 120 according to the present embodiment. First, each of the buy side 30 (i.e. the buy side system 300 or the buy side terminal 31, the same applies below) and the sell side 20 (i.e. the sell side system 200 or the sell side terminal 21, the same applies below) registers IOI information to the POP 120 (i.e. the POP system 100, the same applies below) by using the message of the FIX protocol or the file (S01). The POP 120 performs the matching at a predetermined timing (S02), and notifies each of the object buy side 30 and the object sell side 20 of the matched trade (S03).

Each of the buy side 30 and the sell side 20 that has received the report of the matching result notifies the POP 120 of a response of either Ack (acknowledgement) or Rej (rejection) relative to the matched contents (S04). The POP 120 determines that the trade has been established if both of the responses are Ack (S05), and notifies the buy side 30 and the sell side 20 that the trade has been established (S06). Then, as the conduction of the established trade, an order is placed from the buy side 30 to the sell side 20 by the message of the FIX protocol (S07), and the buy side 30 is notified of the order-execution contents which are a result of the execution on the sell side 20 (S08).

<(2) Matching Between Buy Sides (Designation for Execution Destination)>

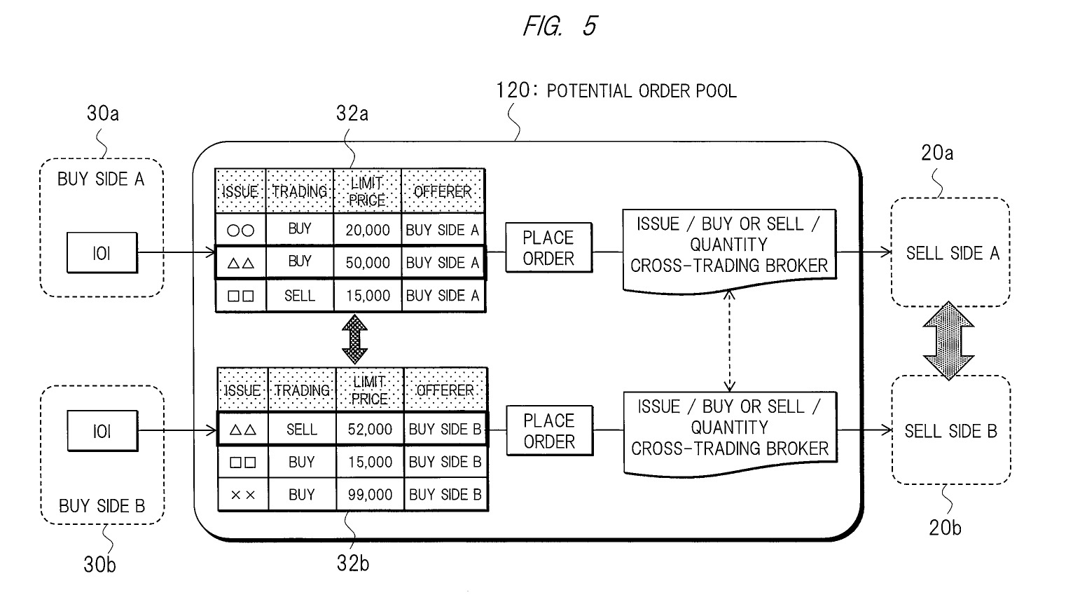

FIG. 5 is a diagram illustrating an outline of an example of matching between the buy sides 30 in the POP 120 according to the present embodiment. As described above, in the present embodiment, the IOI can be matched between the buy sides 30. The example of FIG. 5 shows that the buying and the selling are matched for an issue “ΔΔ” between the IOI 32a provided by the buy side A (30a) and the IOI 32b provided by the buy side B (30b).

In this case, both of the buy sides 30 individually perform the order placement processing to a predetermined sell side 20 with which each of the buy sides 30 has a trading contract. The example of FIG. 5 shows a case of the order placements from the buy side A (30a) to the sell side A (20a) and from the buy side B (30b) to the sell side B (20b). To the order placement information, information of the sell side 20 that is an order placement destination of the buy side 30 that is a counterparty of the matching is added by the buy side system 300 or the POP 120 as information of a broker (sell side 20) that is a cross-trading destination. For example, information of the sell side B (20b) that is an order placement destination of the buy side B (30b) that is a counterparty of the matching is added to the order placement information output from the buy side A (30a).

Accordingly, the sell side 20 that has received the order placement information can check the information of the sell side 20 that is a cross-trading counterparty, and can execute the cross-trading with the sell side 20 to the exchange system 40. Note that the notification of the order execution data from each of the and therefore, a description thereof is omitted.

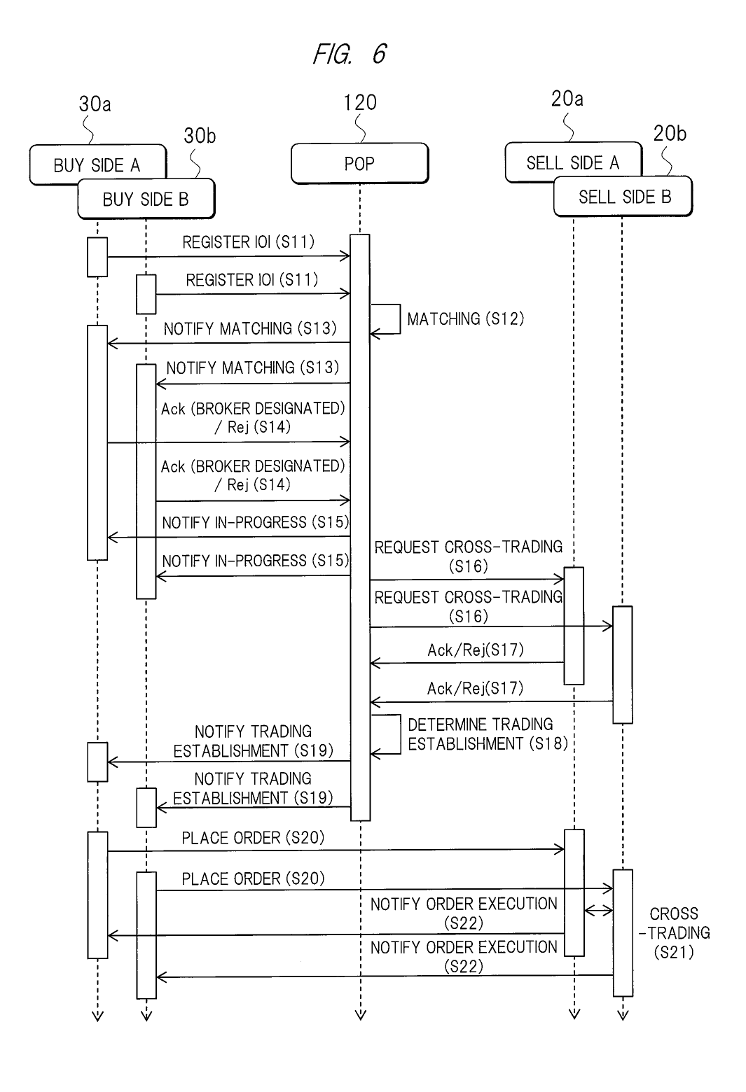

FIG. 6 is a sequence diagram illustrating an outline of an example of matching processing between the buy sides 30 in the POP 120 according to the present embodiment. First, each of the buy sides 30 (two buy sides that are the buy side A (30a) and the buy side B (30b) in the example of FIG. 6) registers IOI information to the POP 120 (S11). The POP 120 performs the matching at a predetermined timing (S12), and notifies each of the buy side A (30a) and the buy side B (30b) of the matched trade (S13).

Each of the buy side A (30a) and the buy side B (30b) that has been notified of the matching result selects a broker (sell side 20) that executes the trade, and notifies the POP 120 of a response of either Ack (acknowledgement) or Rej (rejection) (S14). As described above, the broker described here is, for example, the sell side 20 with which each of the buy sides 30 has a trade contract. The broker may be automatically selected by previously registering the information on the object sell side 20 to the setting DB 124 of the POP system 100 as a default value.

The POP 120 that has received the broker designation notifies the buy side A (30a) and the buy side B (30b) that the trade is in progress (S15), and makes a request for cross-trading to each of the sell sides 20 (the sell side A (20a) and the sell side B (20b) in the example of FIG. 6) that have been designated as the broker (S16). The request includes an issue relative to the cross-trading, information on each of the buy sides 30, information of the broker that is a cross-trading counterparty, and others.

Each of the sell side A (20a) and the sell side B (20b) that has received the request for the cross-trading notifies the POP 120 of a response of either Ack (acknowledgement) or Rej (rejection) (S17). The POP 120 determines that the trade has been established if both of the responses are Ack (S18), and notifies the buy side A (30a) and the buy side B (30b) of the trade establishment (S19).

Then, as the conduction of the established trade, an order is placed from the buy side A (30a) and the buy side B (30b) to the sell side A (20a) and the sell side B (20b) by using a message of the FIX protocol (S20), the cross trading is executed between the sell side A (20a) and the sell side B (20b) (S21), and then, each of the buy side A (30a) and the buy side B (30b) is notified of the order-execution contents (S22). Information required for the cross-trading (S21) may be added to information at the time of order placement (S20). Alternatively, information passed at the time of the request for the cross-trading (S16) may be used.

Note that the above-described example shows the case of the matching between the buy sides 30. However, the same applies to a case of the matching between the sell sides 20.

<(3) Matching Between Buy Sides (Bidding for Commission)>

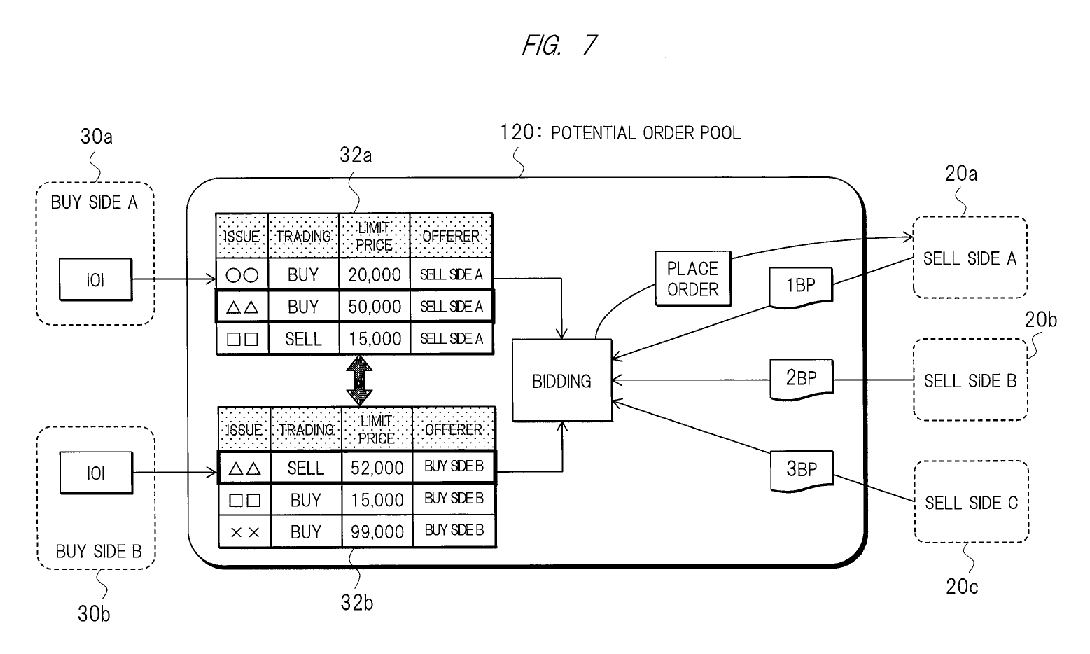

FIG. 7 is a diagram illustrating an outline of another example of the matching between the buy sides 30 in the POP 120 according to the present embodiment. The example of FIG. 7 shows a case in which, after the matching between the buy sides 30 as similar to the matching illustrated in FIG. 5 described above, bidding for a commission is made to a plurality of sell sides 20 with which both of the buy sides 30 have the trade contract and the sell side 20 offering the lowest commission is determined as the order placement destination. That is, the sell side 20 that becomes the order placement destination is determined by “commission competition”. In the example of FIG. 7, the bidding for the commission is made to the sell side A (20a), the sell side B (20b), and a sell side C (20c), and then, the sell side A (20a) that has offered the lowest commission of “1 BP (=0.01%)” is automatically determined as the order placement destination.

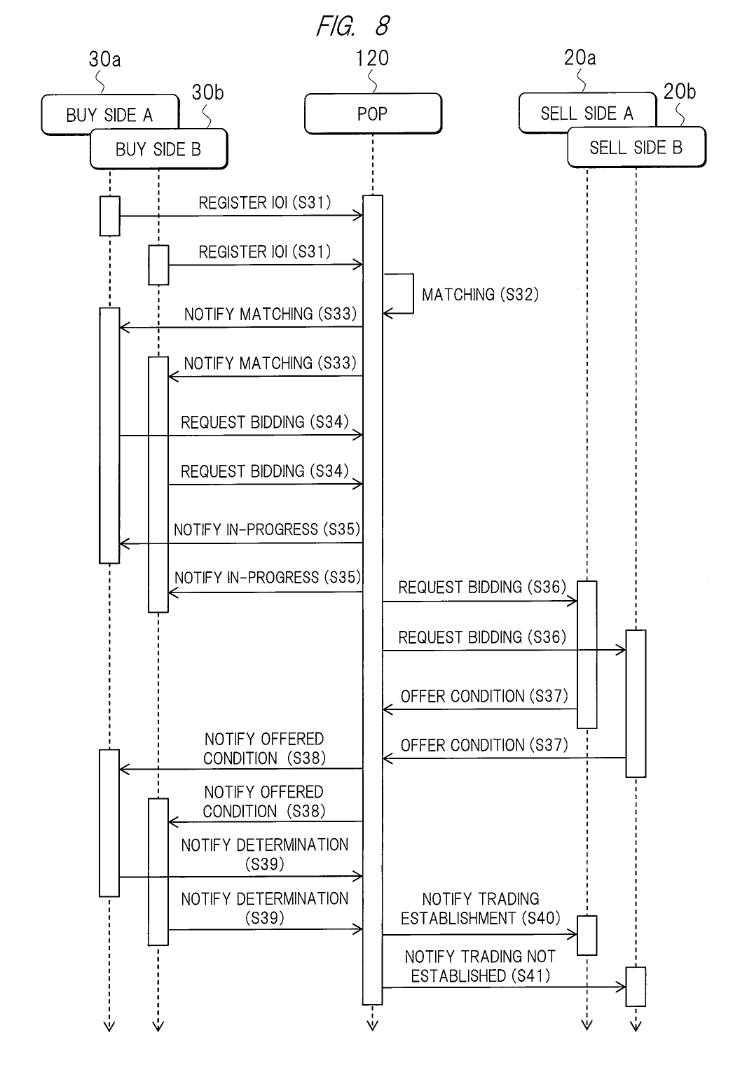

FIG. 8 is a sequence diagram illustrating an outline of another example of matching processing between the buy sides 30 in the POP 120 according to the present embodiment. As similar to the example of FIG. 6 described above, first, each of the buy sides 30 (two buy sides that are the buy side A (30a) and the buy side B (30b) in the example of FIG. 7) registers the IOI information to the POP 120 (S31). The POP 120 performs the matching at a predetermined timing (S32), and notifies each of the buy side A (30a) and the buy side B (30b) of the matched trade (S33).

Each of the buy side A (30a) and the buy side B (30b) that has been notified of the matching result notifies the POP 120 of designation for the selection of the broker (sell side 20) that executes the trade by the bidding for the commission (S34). The POP 120 that has received the request for the bidding notifies the buy side A (30a) and the buy side B (30b) that the trade is in progress (S35), and makes a request for the bidding for the commission to the sell sides 20 (the sell side A (20a) and the sell side B (20b) in the example of FIG. 7) with which each of the buy sides 30 has a trade contract (S36). The bidding includes an issue relative to the trade, a quantity thereof, information on each of the buy sides 30 taking the buying position and the selling position, and others.

Each of the sell side A (20a) and the sell side B (20b) that has received the request for the bidding sets and responds the BP of the commission as a condition offer (S37). A value of the BP may be input and set each time on a sell side system 200 side, or may be previously registered each time to the sell side system 200 or the setting DB 124 of the POP system 100 for each of the buy sides 30. In a case in which the sell side 20 has selected not to participate in the “commission competition”, a fact of the selection can be also responded. A case without the response within a certain time may be automatically handled as the case of no participation.

If the condition has been offered from all of the object sell sides 20 or if a predetermined time has passed, the POP 120 notifies the buy side A (30a) and the buy side B (30b) of a list of the conditions offered from the sell sides 20 (S38). A candidate for the order placement destination is the sell side 20 offering the lowest BP of the commission (if the values of the BP are the same as one another, the sell side 20 that has offered the condition (step S37) at the earliest time). If each of the buy sides 30 is determined as the order placement destination under the condition, the POP 120 is notified of the determination (S39). The POP 120 that has received the determination notification from each of the buy sides 30 notifies the sell side 20 (the sell side A (20a) in the example of FIG. 8) determined as the order placement destination of the trade establishment (S40), and notifies the other sell side 20 (the sell side B (20b) in the example of FIG. 8) of failure of the trade establishment (S41).

By the above-described processing, the buy side 30 can perform the trade under a condition with an advantageous commission. Further, the sell side 20 can participate in a commission competition of a large-quantity order, and can gain an opportunity of consigned buying and selling.

<(4) Matching Between Buy Side and Sell Side (Designation for Execution Destination)>

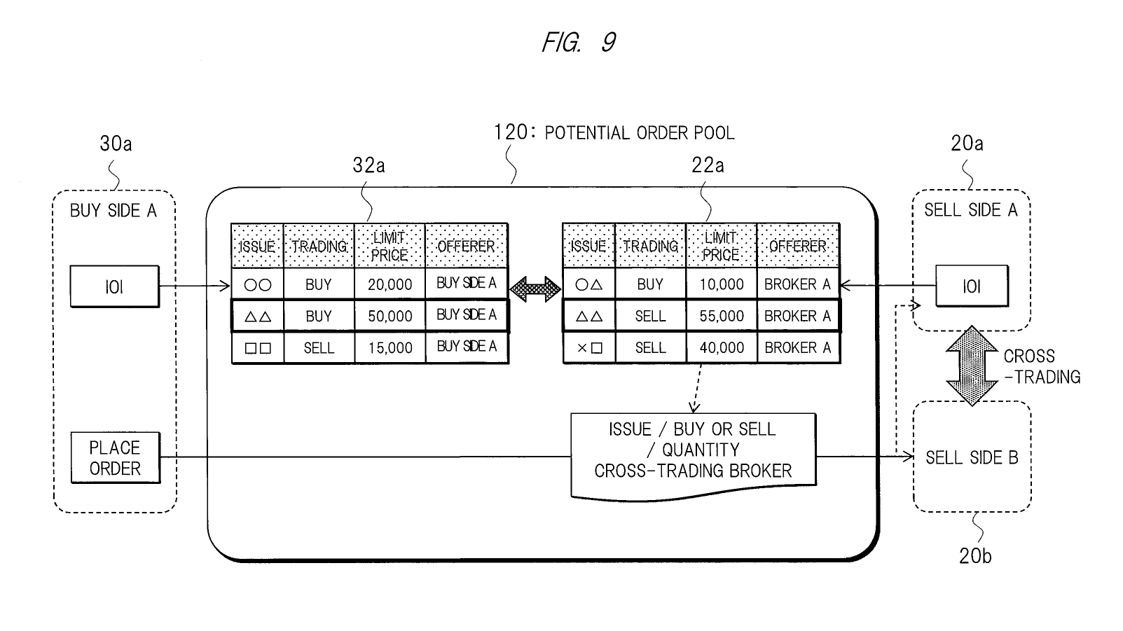

FIG. 9 is a diagram illustrating an outline of another example of matching between the buy side 30 and the sell side 20 in the POP 120 according to the present embodiment. The example of FIG. 9 shows a case of, as a result of the matching between the buy side A (30a) and the sell side A (20a) as similar to the matching illustrated in FIG. 3 described above, placing an order to the sell side B (20b) different from the sell side A (20a) that has been matched.

In this case, information on the order placement is transmitted by a message of the FIX protocol from the buy side system 300 of the buy side A (30a) to the sell side system 200 of the sell side B (20b). To the order placement information, information on the sell side 20 (the sell side A (20a) in the example of FIG. 9) that is the matched counterparty is added by the buy side system 300 or the POP 120. Thus, the sell side B (20b) that has received the order placement information can check the information on the sell side A (20a) to be a cross-trading counterparty, and can execute the cross-trading made with the sell side A (20a) to the exchange system 40.

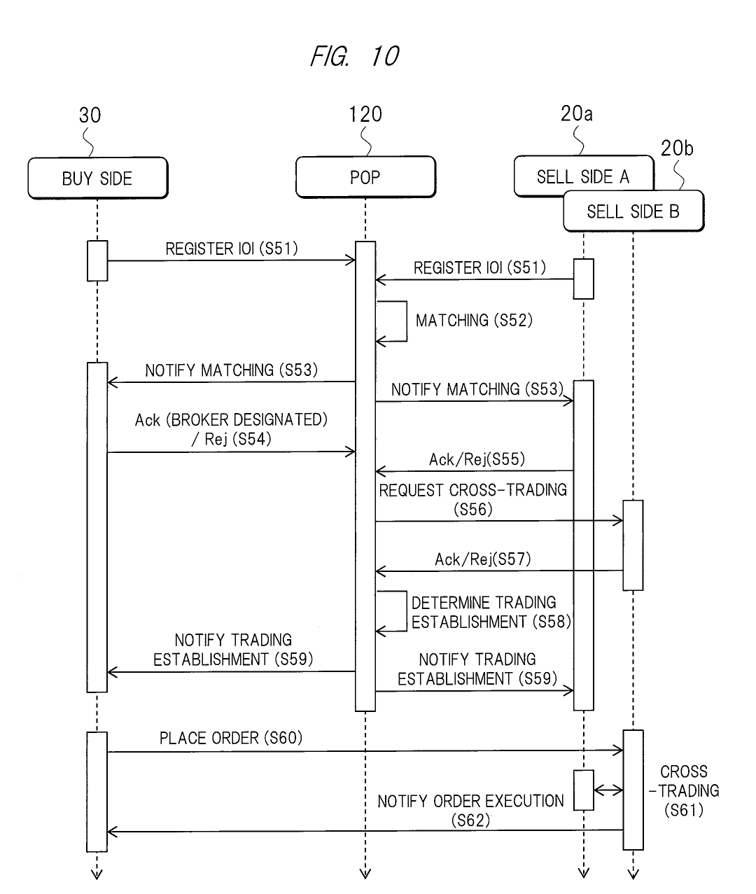

FIG. 10 is a sequence diagram illustrating an outline of an example of matching processing between the buy side 30 and the sell side 20 in the POP 120 according to the present embodiment. As similar to the example of FIG. 4 described above, first, each of the buy side 30 and the sell side A (20a) registers the IOI information to the POP 120 by a message of the FIX protocol or a file (S51). The POP 120 performs the matching at a predetermined timing (S52), and notifies each of the object buy side 30 and the object sell side A (20a) of the matched trade (S53).

The buy side 30 that has received a notification of the matching result selects a broker (sell side 20) that executes the trade, and designates a response of either Ack (acknowledgement) or Rej (rejection) to the POP 120 (S54). As described above, the broker described here is, for example, the sell side 20 (the sell side B (20b) in the example of FIG. 10). The broker may be automatically selected by previously registering the information on the object sell side 20 to the setting DB 124 of the POP system 100 as a default value.

Further, the sell side A (20a) that has received the notification of the matching result notifies the POP 120 of the response of either Ack (acknowledgement) or Rej (rejection) relative to the matched contents (S55). If the POP 120 receives the response of the Ack with the designation for the broker from the buy side 30 and the response of the Ack from the sell side A (20a), the POP 120 makes a request for the cross-trading to the sell side B (20b) that has been designated as the broker (S56). The request includes an issue relative to the cross-trading, information on the buy side 30, information on the broker that is the cross-trading counterparty, and others.

The sell side B (20b) that has received the request for the cross-trading notifies the POP 120 of the response of either Ack (acknowledgement) or Rej (rejection) (S57). If the POP 120 receives the response of Ack, the POP 120 determines of the trade establishment (S58), and notifies the buy side 30 and the sell side A (20a) that the trade has been established (S59). Then, as the conduction of the established trade, an order is placed from the buy side 30 to the sell side 20 by a message of the FIX protocol (S60), the cross-trading is executed between the sell side A (20a) and the sell side B (20b) (S61), and then, the buy side 30 is notified of the order-execution contents (S62).

As similar to the example of FIG. 6 described above, information required for the cross-trading (S61) may be added to information at the time of order placement (S60). Alternatively, information passed at the time of the request for the cross-trading (S56) may be also used.

As described above, in the securities trading management system 1 according to the first embodiment of the present invention, in the POP system 100 operated and managed by a business operator that is neutrally positioned for the buy side 30 and the sell side 20, the IOI information including a potential order of one or more buy sides 30 and the IOI information of one or more sell sides 20 are accumulated and are matched in the POPDB 121. Accordingly, the dark pools of the plurality of sell sides 20 can be linked with one another, and therefore, the buy side 30 can establish the trade under a suitable condition in a broader range. Further, a dark pool service that ensures transparency, fairness, and impartiality can be provided.

Further, a trade that is scheduled to be distributed over a certain period in the future can be executed at a timing causing a more suitable condition by obtaining the potential order of the buy side 30 as the IOI information and setting the potential order as a matching target.

### Second Embodiment

The above-described first embodiment has explained that a case in which the buy side 30 becomes a participant and a case in which the sell side 20 becomes a participant are distinguished from each other in the trade in the POP 120, and explained contents of processing for four possible patterns that are (1) matching between the buy side 30 and the sell side 20, (2) matching between the buy sides 30 (the cross-trading with the designation for the execution destination), (3) matching between the buy sides 30 (the bidding for the commission), and (4) matching between the buy side 30 and the sell side 20 (the designation for the execution destination).

Meanwhile, in consideration of reality, business practices, and others on a practical operation in implementing the securities trading management system 1, it is normally unclear which one of the buy side 30 and the sell side 20 becomes the matching counterparty at the time of matching in the POP 120, and therefore, it is difficult to distinguish a processing flow depending on whether the participant is the sell side 20 or the buy side 30 in some cases.

Further, for example, in the case (1) of the matching between the buy side 30 and the sell side 20, it is normally difficult to cause a case in which the buy side 30 does not designate the sell side 20 (executing broker) that is an execution destination. Similarly, in the case (4) of the matching between the buy side 30 and the sell side 20, for example, even if there is no trade contract between the buy side 30 and the sell side 20 that are matched, it is naturally considered to designate the sell side 20 (executing broker) having the trade contract.

Therefore, it can be considered that, without distinguishing whether the trade counterparty in the POP 120 is the buy side 30 or the sell side 20, it is sufficient to implement two patterns of a case (A) of designating the sell side 20 (executing broker) that is the execution destination after the matching is performed among the participants; and a case (B) of determining the sell side 20 (executing broker) that is the execution destination by a commission competition after the matching is performed among the participants practically.

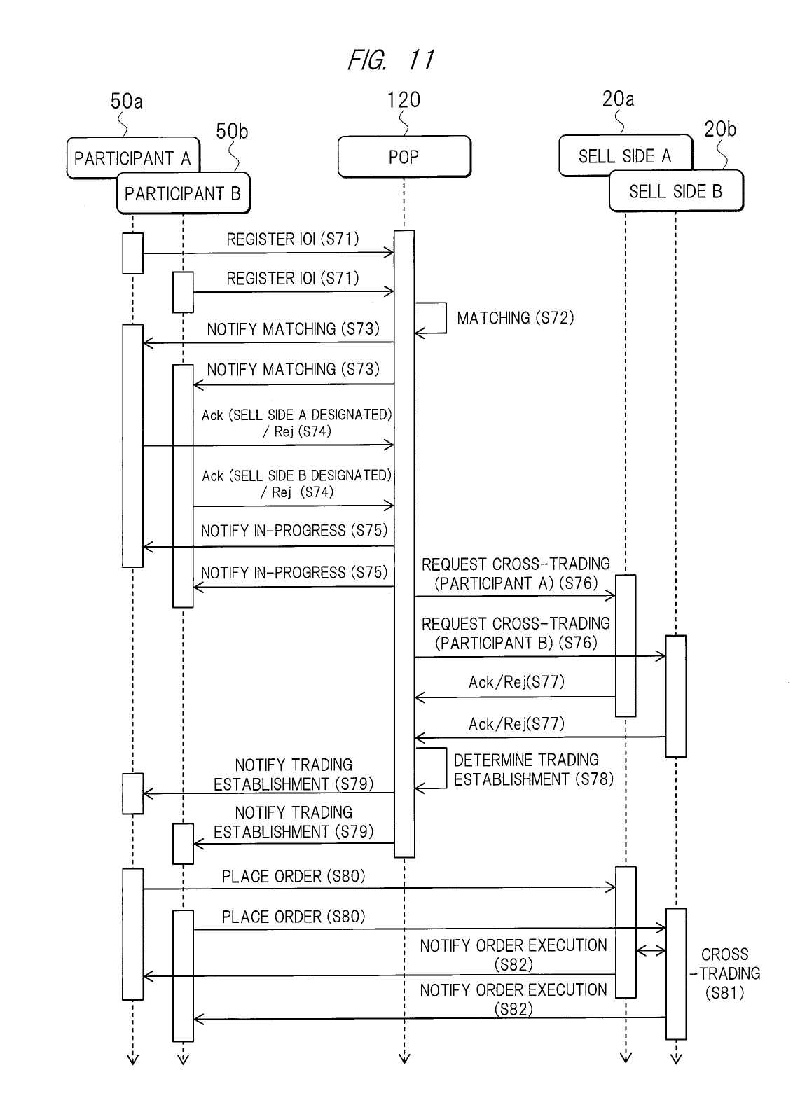

FIG. 11 is a sequence diagram illustrating an outline of an example of matching process between the participants in the POP 120 according to the present embodiment. The following shows a processing flow of the above-described case (A) of designating the executing broker after the matching is performed among the participants. Basically, this processing is the same as the above-described processing of the case (2) of the matching between the buy sides 30 (the cross-trading with the designation for the execution destination) as illustrated in FIG. 6 of the first embodiment, and therefore, a repeated description for overlapping contents is omitted in some cases. As different from the example of FIG. 6, in the example of FIG. 11, the participant in the trade in the POP 120 is not the buy side 30 but a participant 50 (two participants of a participant A (50a) and a participant B (50b) in the example of FIG. 11). The participant 50 may be either the buy side 30 or the sell side 20.

First, each of the participants 50 (two participants of the participant A (50a) and the participant B (50b) in the example of FIG. 11) registers the IOI information to the POP 120 (S71). The POP 120 performs the matching at a predetermined timing (S72), and notifies each of the participant A (50a) and the participant B (50b) of the matched trade (S73). Note that the processing up to here is common between the case (A) of designating the executing broker after the matching is performed between the participants as illustrated in the example of FIG. 11 and a case (B) of determining the executing broker by the commission competition after the matching is performed between the participants as described later.

In the example of FIG. 11, each of the participant A (50a) and the participant B (50b) that has received a notification of the matching result selects a broker (sell side 20) that executes the trade, and notifies the POP 120 of a response of either Ack (acknowledgement) or Rej (rejection) (S74). If the participant 50 is the buy side 30, the broker described here is, for example, the sell side 20 with which this buy side 30 has the trade contract. If the participant 50 is the sell side 20, this sell side 20 itself normally becomes the execution destination. The example of FIG. 11 shows that the participant A (50a) designates the sell side A (20a) as the executing broker while the participant B (50b) designates the sell side B (20b). Note that these executing brokers are the same sell side 20 as each other in some cases.

The POP 120 that has received destination for the broker notifies the participant A (50a) and the participant B (50b) that the trade is in progress (S75), and makes a request for the cross-trading to each of the sell sides 20 (the sell side A (20a) and the sell side B (20b) in the example of FIG. 11) that is designated as the broker (S76). The request includes an issue relative to the cross-trading, information on each of the buy sides 30, information on the broker that is a cross-trading counterparty, and others. In the example of FIG. 11, the cross-trading for the trade of the participant A (50a) is requested to the sell side A (20a) designated by the participant A (50a) while the cross-trading for the trade of the participant B (50b) is requested to the sell side B (20b) designated by the participant B (50b).

Each of the sell side A (20a) and the sell side B (20b) that has received the request for the cross-trading notifies the POP 120 of a response of either Ack (acknowledgement) or Rej (rejection) (S77). The POP 120 determines the trade establishment if both of the responses are Ack (S78), and notifies the participant A (50a) and the participant B (50b) that the trade has been established (S79).

Then, as the conduction of the established trade, an order is placed from the participant A (50a) and the participant B (50b) to the sell side A (20a) and the sell side B (20b) that are the respective executing brokers by a message of the FIX Protocol (S80). After the cross-trading is executed between the sell side A (20a) and the sell side B (20b) through the exchange system 40 (S81), each of the participant A (50a) and the participant B (50b) is notified of the order-execution contents (S82).

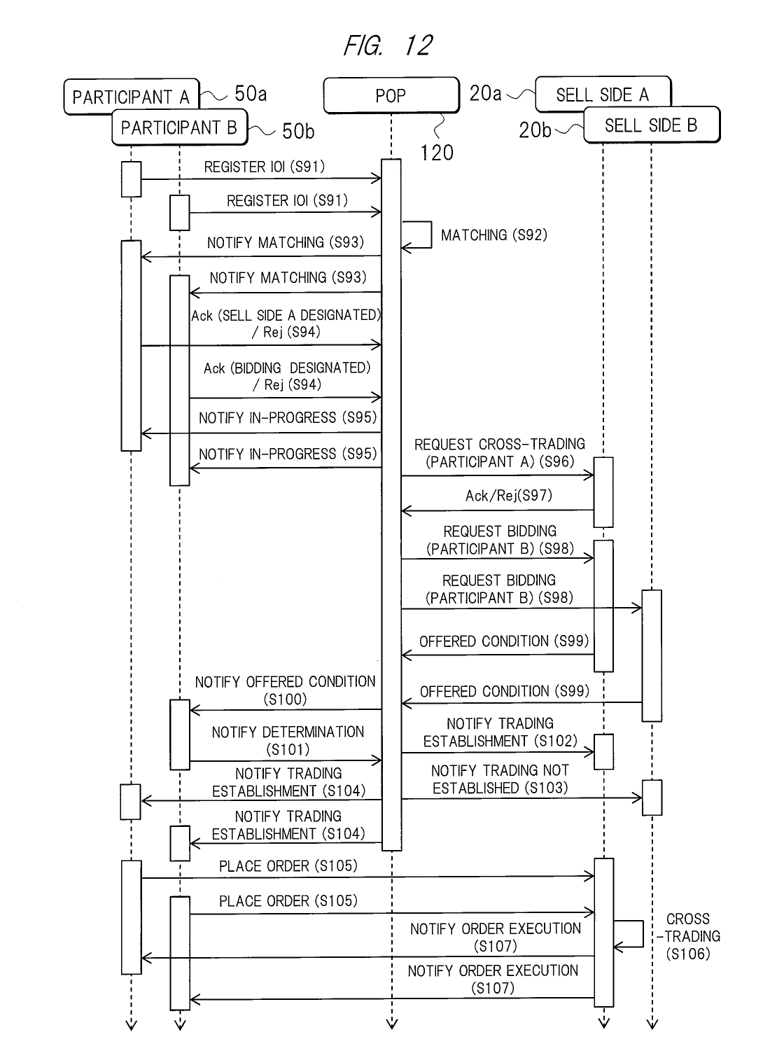

FIG. 12 is a sequence diagram illustrating an outline of another example of the matching processing between the participants in the POP 120 according to the present embodiment. The following shows a processing flow of the above-described case (B) of determining the executing broker by the commission competition after the matching is performed between the participants. Basically, this processing is the same as the above-described processing of the case (3) of the matching between the buy sides 30 (the bidding for the commission) as illustrated in FIG. 8 of the first embodiment, and therefore, a repeated description for overlapping contents is omitted in some cases. Further, as described above, the processing of steps S91 to S93 in the example of FIG. 12 is common to steps S71 to S73 in the example of FIG. 11.

In the example of FIG. 12, as similar to the example of FIG. 11, the participant A (50a) that has received a notification of the matching result selects the sell side A (20a) as a broker (sell side 20) that executes the trade, and notifies the POP 120 of a response of either Ack (acknowledgement) or Rej (rejection) (S94). On the other hand, as different from the example of FIG. 11, the participant B (50b) that has received a notification of the matching result notifies the POP 120 of a response of either Ack (acknowledgement) or Rej (rejection) designating the selection for the broker (sell side 20) that executes the trade based on bidding for a commission (S94). The example of FIG. 12 shows a case in which only the participant B (50b) that is one of the participants 50 designates the commission competition. However, the same applies to a case in which both of the participant A (50a) and the participant B (50b) designate the commission competition.

The POP 120 that has received the designation for the bidding for the commission (and the designation for the broker) notifies the participant A (50a) and the participant B (50b) that the trade is in progress (S95), and, if the broker is designated, makes a request for the cross-trading to each of the designated sell sides 20 (the sell side A (20a) designated by the participant A (50a) in the example of FIG. 12) (S96). The sell side A (20a) that has received the request for the cross-trading notifies the POP 120 of a response of either Ack (acknowledgement) or Rej (rejection) (S97).

Further, based on the designation for the bidding for the commission, the POP 120 makes the request for the bidding for the commission to each of the sell sides 20 (the sell side A (20a) and the sell side B (20b) in the example of FIG. 12) (S98). The bidding includes an issue relative to the trade, a quantity thereof, information on the participants 50 taking the buying position and the selling position (the participant B (50b) that has designated the bidding for the commission in the example of FIG. 12), and others. Each of the sell side A (20a) and the sell side B (20b) that has received the request for the bidding sets a BP of the commission as a condition offer, and notifies the POP 120 of a response of either Ack (acknowledgement) or Rej (rejection) (S99). Note that, if both of the participants 50 have designated the bidding for the commission, each of the sell sides 20 accepts both of the inquiries, and offers the condition to each of them.

If the condition has been offered from all of the object sell sides 20 or if a predetermined time has passed, the POP 120 notifies each of the participants (the participant B (50b) in the example of FIG. 12) that has designated the bidding for the commission of a list of the conditions offered from the sell sides 20 (S100). As similar to the example of FIG. 8, a candidate for the order placement destination is the sell side 20 offering the lowest BP of the commission (if the values of the BP are the same as one another, the sell side 20 that has offered the condition (step S99) at the earliest time). If each of the participants 50 is determined as the order placement destination under the condition, the POP 120 is notified of the determination (S101).

The POP 120 that has received the determination notification from each of the participants 50 notifies the sell side 20 (the sell side A (20a) in the example of FIG. 12) determined as the order placement destination (S102), and notifies the other sell side 20 (the sell side B (20b) in the example of FIG. 12) of failure of the trade establishment (S103). Further, it also notifies each of the participants 50 of the trade establishment (S104).

In the example of FIG. 12, note that the executing broker designated by the participant A (50a) and the sell side 20 that is the order placement destination determined as the result of the bidding for the commission designated by the participant B (50b) are the same sell side A (20a) as each other. Thus, both of the participant A (50a) and the participant B (50b) place an order to the sell side A (20a) (S105), the cross-trading is executed by the sell side A (20a) through the exchange system 40 (S106), and then, each of the participant A (50a) and the participant B (50b) is notified of a notification of the order execution (S107).

In the foregoing, the invention made by the present inventors has been concretely described based on the embodiments. However, it is needless to say that the present invention is not limited to the foregoing embodiments and various modifications and alterations can be made within the scope of the present invention. For example, the above-described embodiments have been explained for easily understanding the present invention, and are not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

### INDUSTRIAL APPLICABILITY

The present invention is applicable to a securities trading management system that supports operations relative to order placement and acceptance of a trade and an order-execution processing.

### EXPLANATION OF REFERENCE CHARACTERS

1 . . . securities trading management system, 10 . . . network, 20 . . . sell side, 20a . . . sell side A, 20b . . . sell side B, 20c . . . sell side C, 21 . . . sell side terminal, 22a, b . . . IOI, 30 . . . buy side, 30a . . . buy side A, 30b . . . buy side B, 31 . . . buy side terminal, 32a, b . . . IOI, 40 . . . exchange system, 50a . . . participant A, 50b . . . participant B,
100 . . . potential order pool system, 110 . . . matching processing unit, 120 . . . potential order pool, 121 . . . potential order pool DB, 122 . . . buy side master DB, 123 . . . sell side master DB, 124 . . . setting DB,
200 . . . sell side system, 210 . . . sell side OMS, 220 . . . back system, 300 . . . buy side system, 310 . . . buy side OMS, 320 . . . back system

1. A securities trading management system accepting an order from a counterparty and managing securities trading performed by a sell side, the securities trading management system comprising:
one or more information processing systems including an order management system managing the order from the counterparty on a buy side or a sell side being a participant participating in the securities trading; and
a potential order pool system recording, in a database, information of an IOI (Indication of Interest) of each of the participants obtained from each of the information processing systems, and matching buying and selling between orders included in the respective IOI,
wherein at least either one of the orders matched by the potential order pool system includes a potential order being an order scheduled to be executed by the participant in the future,
relative to an order being matched between a first participant and a second participant, the potential order pool system notifies a first information processing system of a sell side being an execution destination designated by the first participant and a second information processing system of a sell side being an execution destination designated by the second participant of a request for executing a cross-trading relative to the order, and notifies a third information processing system of the first participant and a fourth information processing system of the second participant of establishment of the trading relative to the order if the potential order pool system receives a notification of acknowledgement from both of the first information processing system and the second information processing system,
the third information processing system places the order to the first information processing system,
the fourth information processing system places the order to the second information processing system, and
the cross-trading relative to the order is executed between the first information processing system and the second information processing system.

2. The securities trading management system according to claim 1,
wherein the potential order pool system matches buying and selling between an order included in an IOI of the buy side being the participant and an order included in an IOI of the sell side being the participant.

3. The securities trading management system according to claim 1,
wherein the potential order pool system matches buying and selling between an order included in an IOI of a first buy side being the participant and an order included in an IOI of a second buy side being the participant.

4. The securities trading management system according to claim 1,
wherein the potential order pool system matches buying and selling between an order included in an IOI of a first sell side being the participant and an order included in an IOI of a second sell side being the participant.

5. A securities trading management system accepting an order from a counterparty and managing securities trading performed by a sell side, the securities trading management system comprising:
one or more information processing systems including an order management system managing the order from the counterparty on a buy side or a sell side being a participant participating in the securities trading; and
a potential order pool system recording, in a database, information of an IOI (Indication of Interest) of each of the participants obtained from each of the information processing systems, and matching buying and selling between orders included in the respective IOI,
wherein at least either one of the orders matched by the potential order pool system includes a potential order being an order scheduled to be executed by the participant in the future,
relative to an order being matched between a first participant and a second participant, the potential order pool system notifies a first information processing system of a sell side being an execution destination designated by the first participant of a request for executing a cross-trading relative to the order,
relative to bidding for a commission designated by the second participant, the potential order pool system makes the bidding for the commission to the information processing system of each of the sell sides being the participants, and determines the sell side offering the most advantageous commission as an order placement destination, and the potential order pool system notifies a third information processing system of the first participant, a fourth information processing system of the second participant, and the information processing system of each of the sell sides to which the bidding for the commission has been made of establishment of a trading relative to the order if the potential order pool system receives a notification of acknowledgement relative to the cross-trading from the first information processing system,
the third information processing system places the order to the first information processing system,
the fourth information processing system places the order to the second information processing system of the sell side determined as the order placement destination, and
the cross-trading relative to the orders is executed between the first information processing system and the second information processing system.

6. A securities trading management system accepting an order from a counterparty and managing securities trading performed by a sell side, the securities trading management system comprising:
one or more information processing systems including an order management system managing the order from the counterparty on a buy side or a sell side being a participant participating in the securities trading; and
a potential order pool system recording, in a database, information of an IOI (Indication of Interest) of each of the participants obtained from each of the information processing systems, and matching buying and selling between orders included in the respective IOI,
wherein at least either one of the orders matched by the potential order pool system includes a potential order being an order scheduled to be executed by the participant in the future,
relative to an order being matched between a first participant and a second participant and relative to inquiries about a commission designated by the first participant and the second participant, the potential order pool system makes the inquiries about the commission to the information processing system of each of the sell sides being the participants, and determines the sell sides offering the most advantageous commissions relative to the respective inquiries as a first order placement destination and a second order placement destination, and the potential order pool system notifies a first information processing system of the first participant, a second information processing system of the second participant, and the information processing system of each of the sell sides to which the inquiries inquiries about the commission has been made of establishment of a trading relative to the order,
the first information processing system places the order to the third information processing system of the sell side determined as the first order placement destination,
the second information processing system places the order to the fourth information processing system of the sell side determined as the second order placement destination, and
the cross-trading relative to the orders is executed between the third information processing system and the fourth information processing system.
